(19) United States
(12) Patent Application Publication
(10) Pub. No.: US 2021/0065019 A1
(43) Pub. Date: Mar. 4, 2021

(54) USING A DIALOG SYSTEM FOR LEARNING AND INFERRING JUDGMENT REASONING KNOWLEDGE

(71) Applicant: INTERNATIONAL BUSINESS MACHINES CORPORATION, Armonk, NY (US)

(72) Inventors: Oznur ALKAN, DUBLIN (IE); Adi BOTEA, DUBLIN (IE); Akihiro KISHIMOTO, DUBLIN (IE); Radu MARINESCU, DUBLIN (IE); Biplav SRIVASTAVA, Rye, NY (US)

(73) Assignee: INTERNATIONAL BUSINESS MACHINES CORPORATION, Armonk, NY (US)

(21) Appl. No.: 16/554,233

(22) Filed: Aug. 28, 2019

(51) Int. Cl. G06N 5/04; G06N 5/02; G06N 20/00; G06F 16/24

(52) U.S. Cl. CPC G06N 5/04; G06F 16/24; G06N 20/00; G06N 5/02

(57) ABSTRACT

Various embodiments are provided for applying judgment reasoning knowledge in a dialog system in a computing environment by a processor. A determination is made that a response to a query during a dialog using the dialog system fails to comply with one or more expected response patterns to one of a plurality of query responses. An updated response may be provided to the query using judgment reasoning knowledge for matching the updated response with the one or more expected response patterns.

### BACKGROUND OF THE INVENTION

### Field of the Invention

The present invention relates in general to computing systems, and more particularly, to various embodiments for using a dialog system for applying and inferring judgment reasoning knowledge in a dialog system in a computing environment using a computing processor.

### Description of the Related Art

In today's society, consumers, businesspersons, educators, and others communicate over a wide variety of mediums in real time, across great distances, and many times without boundaries or borders. The advent of computers and networking technologies have made possible the increase in the quality of life while enhancing day-to-day activities.

Computing systems may be found in the workplace, at home, or at school. Due to the recent advancement of information technology and the growing popularity of the Internet, a wide variety of computer systems have been used in machine learning. Machine learning is a form of artificial intelligence that is employed to allow computers to evolve behaviors based on empirical data. Machine learning may take advantage of training examples to capture characteristics of interest of their unknown underlying probability distribution. Training data may be seen as examples that illustrate relations between observed variables.

A major focus of machine learning research is to automatically learn to recognize complex patterns and make intelligent decisions based on data. As great strides and advances in technologies come to fruition, these technological advances can be then brought to bear in everyday life.

### SUMMARY OF THE INVENTION

Various embodiments are provided for applying judgment reasoning knowledge in a dialog system in a computing environment by a processor. A determination is made that a response to a query during a dialog using the dialog system fails to comply with one or more expected response patterns to one of a plurality of query responses. An updated response may be provided to the query using judgment reasoning knowledge for matching the updated response with the one or more expected response patterns

In addition to the foregoing exemplary method embodiment, other exemplary system and computer product embodiments are provided and supply related advantages.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting an exemplary functional relationship between various aspects of the present invention;

FIG. 5 is an additional block diagram depicting applying and inferring judgment reasoning knowledge in a dialog system in a computing environment in accordance with an embodiment of the present invention;

FIG. 6 is a flowchart diagram depicting an exemplary method for applying and inferring judgment reasoning knowledge in a dialog system in a computing environment in accordance with an embodiment of the present invention;

FIG. 7 is a flowchart diagram depicting an additional exemplary method for applying and inferring judgment reasoning knowledge in a dialog system in a computing environment in accordance with an embodiment of the present invention; and

FIG. 8 is a flowchart diagram depicting an additional exemplary method for applying and inferring judgment reasoning knowledge in a dialog system in a computing environment in accordance with an embodiment of the present invention.

### DETAILED DESCRIPTION OF THE DRAWINGS

As a preliminary matter, computing systems may include large scale computing called “cloud computing,” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

Moreover, dialog systems play a key role in the functioning of an organization, such as a business, government, group or other entity. For example, many critical decisions may result from discussions in chat systems, or chat-like conversation systems or chatbots. A chatbot may be an operation which conducts a dialog or conversation, audible, visual, and/or via textual methods. Organizations may seek to capture and analyze these decisions to make various improvements to a structure of the organization. However, current dialog systems, along with Artificial Intelligence (“AI”)/machine learning systems, are unable to understand, learn, and acquire commonsense knowledge (e.g., judgment reasoning knowledge), which then may be used, applied, and/or even inferred during the course of a dialog with a dialog system. Said differently, many AI systems/dialog systems exhibit great difficulty in the providing the capabilities of reasoning, learning, and applying human-type commonsense knowledge. In one aspect, “judgment reasoning knowledge” may be defined as the collective judgment, position, and opinion of the community of persons, entities, organizations, groups, cultures, academia, scientists, or other in a particular field of study or topic area. Also, the judgment reasoning knowledge may also be defined as something widely known or understood, which may be learned and reasoned via artificial intelligence. In an additional aspect, commonsense knowledge (e.g., “judgment reasoning knowledge) may relate to a machine learning operation able to learn, create, train, and/or augment operations and/or rules about executing one or more operations/tasks with knowledge of the actual or simulated environment, and with reasoning skills to adapt the operations and/or rules to the environment in an appropriate manner and this integrated ability may be referred to as “commonsense reasoning.”

In artificial intelligence, commonsense knowledge (e.g., “judgment reasoning knowledge”) may relate to simulating the human ability to make presumptions and reasoning about the type and essence of ordinary situations such as, for example, activities of daily living (“ADLs”). These assumptions include judgments about the physical properties, purpose, intentions and behavior of people and objects, as well as possible outcomes of their actions and interactions. A machine learning model/system that applies commonsense reasoning (e.g., “judgment reasoning knowledge”) may be capable of predicting results and reasoning/drawing conclusions that are similar to humans (e.g., humans' innate ability to reason about people's or organizational behavior and intentions and natural understanding of a physical world.)

For example, consider the following conversation between a dialog system and a user. The dialog system provides the query of “How about this steak restaurant?” to which the user responds, “I am a vegetarian.” It's obvious to the user that the response to the question is negative, even though no explicit negation is given in the answer. Moreover, the user's response also fails to provide an expected response pattern such as, for example, a Yes/No response pattern since the query calls for either a “yes” or a “no” type response.

However, from the perspective of the dialog system, the response may be misinterpreted or even interpreted as non-responsive. Accordingly, various embodiments of the present invention provide a computer system that may apply and infer judgment reasoning knowledge (e.g., commonsense knowledge) in a dialog system or one or more users. The computer system may be a dialog system (e.g., dialog agent) capable of automatically reasoning, learning, and applying human-type commonsense knowledge and extracting the implicit meaning from each user response. In one aspect, the present invention may determine that a response to a query during a dialog using the dialog system fails to comply with one or more expected response patterns to one of a plurality of query responses. An updated response may be provided to the query using judgment reasoning knowledge for matching the updated response with the one or more expected response patterns.

In an additional aspect, a trigger for inferring common sense knowledge during a conversation with a user in a multi-user dialog system (e.g., a chatbot) may be detected by taking into account context of the user and purpose of the dialog. Additionally, a comment, statement, and/or query/question (e.g., a communication) may be provided, suggested, and/or communicated that is associated with a pattern of one or more expected response patterns (e.g., a yes/no response type pattern) by a dialog system. Each response provided by a user to the comment/statement and/or query/question may be determined that that it fails match the expected pattern of possible response. Thus, a new query/question using one or more keywords and/or concepts from the user's response and/or from the original query/question may be created for posting a comment/statement and/or query/question to a knowledge base (or knowledge domain or ontology such as, for example, one or more query-answering system such as, for example, the Internet. One or more search results obtained and/or received from the knowledge base may be used for mapping the user's original response into an updated response that matches the expected pattern of possible response. The newly acquired knowledge (e.g., judgment reasoning knowledge) may be extracted from each search result response and used in a machine learning operation to learn and train a machine learning model for applying, learning, and inferring common sense knowledge (e.g., judgment reasoning knowledge).

In an additional aspect, mechanisms of the illustrated embodiments provide an intelligent dialog system having (or having access to) a knowledge or ontology about one or several domains with the ability to apply, learn, and infer common sense knowledge (e.g., judgment reasoning knowledge). The intelligent dialog system may be in communication with an interactive graphical user interface (“GUI”) or other computing systems such as, for example, an Internet of Things (“IoT”) computing device.

It should be noted as described herein, the term “intelligent” (or “cognition”) may be relating to, being, or involving conscious intellectual activity such as, for example, thinking, reasoning, or remembering, that may be performed using a machine learning. In an additional aspect, intelligent or “intelligence” may be the mental process of knowing, including aspects such as awareness, perception, reasoning and judgment. A machine learning system may use artificial reasoning to interpret data from one or more data sources (e.g., sensor-based devices or other computing systems) and learn topics, concepts, judgment reasoning knowledge, and/or processes that may be determined and/or derived by machine learning.

In an additional aspect, intelligent or “intelligence” may refer to a mental action or process of acquiring knowledge and understanding through thought, experience, and one or more senses using machine learning (which may include using sensor-based devices or other computing systems that include audio or video devices). Intelligent or “intelligence” may also refer to identifying patterns of behavior, leading to a “learning” of one or more problems, domains, events, operations, or processes. Thus, an intelligent (e.g., cognitive) model may, over time, develop semantic labels to apply to observed behavior, domains, problems, judgment reasoning knowledge and use a knowledge domain or ontology to store the learned observed behavior, problems, judgment reasoning knowledge, and domain. In one embodiment, the system provides for progressive levels of complexity in what may be learned from the one or more dialogs, operations, or processes.

In an additional aspect, the term intelligent or “intelligence” may refer to an intelligent or “intelligence” system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A intelligent system may perform one or more computer-implemented intelligent/cognitive operations that approximate a human thought process while enabling a user or a computing system to interact in a more natural manner. An intelligent system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the intelligent/cognitive operation(s), examples of which include, but are not limited to, question answering, identifying problems, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

Additional aspects of the present invention and attendant benefits will be further described, following.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security parameters, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

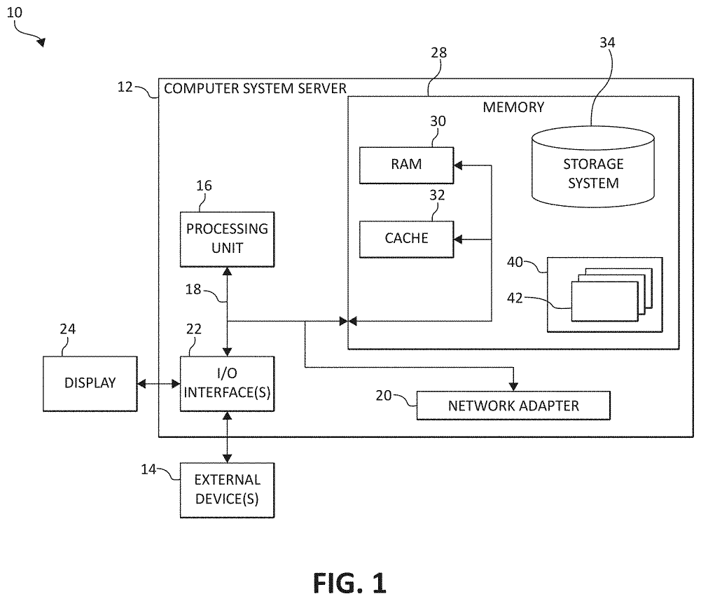

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

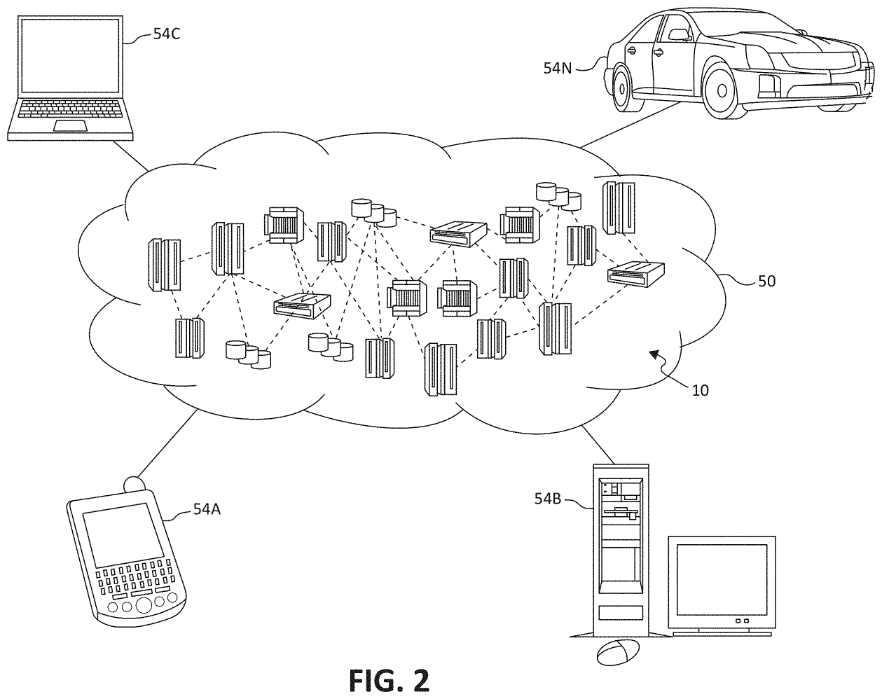

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or other type of computer systems 54N (e.g., an automobile computer system) may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

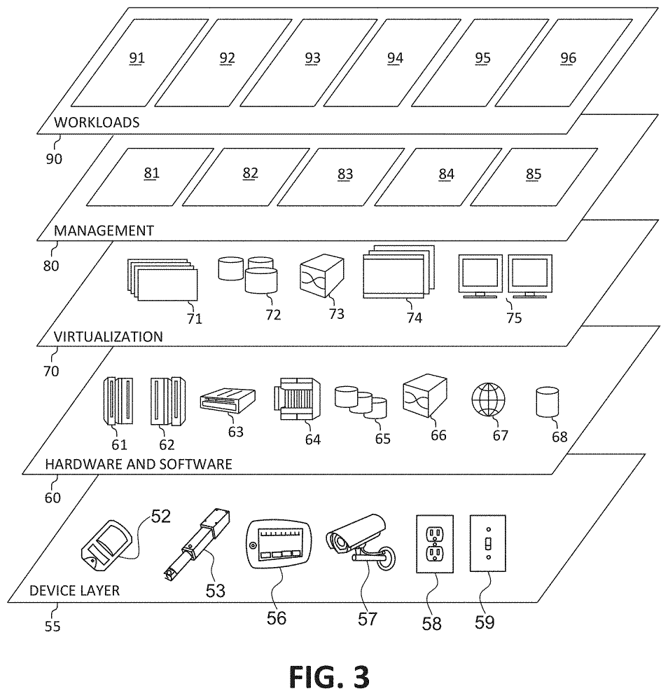

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, workloads and functions 96 for applying and inferring judgment reasoning knowledge in a dialog system. In addition, the workloads and functions 96 for applying and inferring judgment reasoning knowledge in a dialog system may include such operations as data analytics, data analysis, and as will be further described, notification functionality. One of ordinary skill in the art will appreciate that the workloads and functions 96 for applying and inferring judgment reasoning knowledge in a dialog system may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

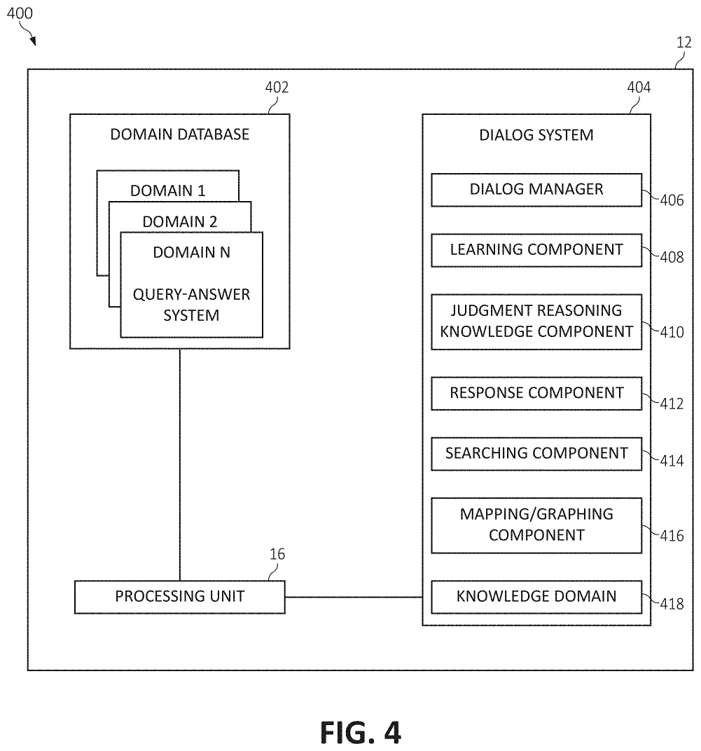

Turning now to FIG. 4, a block diagram depicting exemplary functional components 400 according to various mechanisms of the illustrated embodiments is shown. FIG. 4 illustrates workloads and functions for applying and inferring judgment reasoning knowledge in a dialog system for a user in a computing environment. As will be seen, many of the functional blocks may also be considered “modules” or “components” of functionality, in the same descriptive sense as has been previously described in FIGS. 1-3. With the foregoing in mind, the module/component blocks 400 may also be incorporated into various hardware and software components of a system for cognitive data curation in accordance with the present invention. Many of the functional blocks 400 may execute as background processes on various components, either in distributed computing components, or on the user device, or elsewhere. Computer system/server 12 is again shown, incorporating processing unit 16 (and memory 28 of FIG. 1—not shown for illustrative convenience) to perform various computational, data processing and other functionality in accordance with various aspects of the present invention.

The system 400 may include a domain database 402 and a dialog system 404. The dialog system 404 may include a dialog manager 406, a learning component 408, and a judgment reasoning knowledge component 410, a response component 412, a searching component 414, a mapping/graphing component 416, and a knowledge domain component 418). The system 400 is a system that integrates into a dialog system with the ability to learn, apply, and infer judgment reasoning knowledge from one or more knowledge bases (e.g., multiple domains such as, for example, domain 1, domain 2, and domain N).

The domain database 402 and the dialog system 404 may each be associated with and/or in communication with each other, by one or more communication methods, such as a computing network. In one example, the domain database 402 and the dialog system 404 may be controlled by an owner, customer, or technician/administrator associated with the computer system/server 12.

In one aspect, the computer system/server 12 may provide virtualized computing services (i.e., virtualized computing, virtualized storage, virtualized networking, etc.) to the domain database 402 and the dialog system 404. More specifically, the computer system/server 12 may provide virtualized computing, virtualized storage, virtualized networking and other virtualized services that are executing on a hardware substrate.

As depicted in FIG. 4, the domain database 402 may be one or more knowledge domains that may also include an ontology, knowledge base, and/or other data.

The knowledge domain of the domain database 402 may have multiple knowledge domains (e.g., domain 1, domain 2, and/or domain N) and may be a combination of domains, concepts, relationships between the domains or concepts, machine learning data, features, parameters, data, profile data, historical data, tested and validated data, or other specified/defined data for testing, monitoring, validating, detecting, learning, analyzing, monitoring, and/or maintaining data, concepts, and/or relationships between the concepts. In an additional aspect, the knowledge domain of the domain database 402 may be and/or provide a query-search system such as, for example, the internet.

In one aspect, the dialog system 404 may define one or more problem instances for multiple domains according to a problem instance template, identified user intent, links to one or more problem solvers associated with the multiple domains, or a combination thereof.

The dialog manager 406, working in conjunction with the judgment reasoning knowledge component 410, may provide to a user communication (e.g., a query) associated with a pattern of possible/expected responses to the communication. The response component 412 may analyze the response to the communication received from user and determine (e.g., identify, determine, recognize, analyze, etc.) that the response fails to match one or more possible/expected patterns of possible responses. That is, the dialog manager 406, working in conjunction with the judgment reasoning knowledge component 410, may determine a response to a query during a dialog with a user using the dialog system 404 fails to comply with one or more expected response patterns to one of a plurality of query responses.

The response component 412 may generate, create, and/or provide a reconstructed query using one or more selected terms, concepts, or a combination thereof obtained from the query, the response, or a combination thereof. The response component 412 may submit the reconstructed query to the domain database 402, which may be to one or more knowledge domains such as, for example, knowledge domain 1, knowledge domain 2, and/or knowledge domain N.

The search component 414 may obtain one or more search results from the domain database 402 in response to submitting the reconstructed query.

The mapping/graphing component 416 may map the one or more search results into the updated response. The mapping/graphing component 416 may also map the response relating to one or more concepts with one or more search results in a plurality of tables representing each knowledge domain. The mapping/graphing component 416 may create one or more graphs with a plurality of nodes representing a plurality of cells of each table corresponding to each knowledge domain (e.g., knowledge domain 1, knowledge domain 2, and/or knowledge domain N). Each of the plurality of cells of each table may represent a one or more concepts. The mapping/graphing component 416 may identify a link between one or more of the plurality of nodes having a semantic similarity and even assign a weighted value between each path of each link between the one or more of the plurality of nodes.

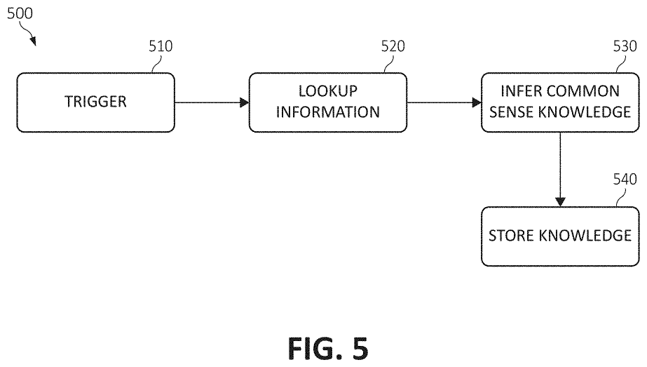

The learning component 408, in association with the judgment reasoning knowledge component 410, may initialize a machine learning operation to learn, extract, and infer the judgment reasoning knowledge. That is, the learning component 408, in association with the judgment reasoning knowledge component 410, may understand, learn, and acquire commonsense knowledge (e.g., judgment reasoning knowledge), which then may be used, applied, and/or even inferred during the course of a dialog between the dialog system and one or more users. Said differently, the dialog system 404 may provide the capabilities of reasoning, learning, and applying human-type commonsense knowledge. The learning component 408 may learn and extract the judgment reasoning knowledge from the one or more search results received by the searching component 414. The learning component 408 may initialize a machine learning mechanism upon detecting a trigger (see FIG. 5) to learn, extract, and infer the judgment reasoning knowledge. The learning component 408 may use one or more machine learning operations (e.g., an instance of IBM® Watson® such as Watson® Assistant). (IBM® and Watson® are trademarks of International Business Machines Corporation.) The learning component 408 may use natural language processing (NLP) and artificial intelligence (AI) may also be used to learn, extract, and infer the judgment reasoning knowledge.

The judgment reasoning knowledge component 410 may provide an updated response to the query using judgment reasoning knowledge for matching the updated response with the one or more expected response patterns. The judgment reasoning knowledge component 410 may store any learned judgment reasoning knowledge in the knowledge domain 418 while extracting, learning, applying, inferring, and/or suggesting various types of judgment reasoning knowledge and/or patterns of possible/expected responses to any type or form of communication.

It should be noted that learning component 408 may be a machine learning component for training and learning one or more machine learning models and also for learning, applying inferences, and/or reasoning pertaining to one or more domains, concepts, features, problems and relationships between the domains, or a combination thereof to the machine learning model for the dialog manager 406. For example, the learning component 408 may learn one or more preferences for variables in a selected domain, one or more preferences for one or more user interface (“UP”) elements for multiple domains, a modeling cost and cognitive load. The learning component 408 may be used to personalize a dialog interface based on the learning.

In one aspect, the learning component 408 may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

Turning now to FIG. 5, a block diagram of exemplary functionality 500 relating to applying and inferring judgment reasoning knowledge in a dialog system according to various aspects of the present invention. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIGS. 1-4. With the foregoing in mind, the module blocks 500 may also be incorporated into various hardware and software components of a system for applying and inferring judgment reasoning knowledge in a dialog system in accordance with the present invention. Many of the functional blocks 500 may execute as background processes on various components, either in distributed computing components, or on the user device, or elsewhere.

Starting with block 510, a trigger component (see also the response component 412 of FIG. 4) may detect a trigger for learning judgment reasoning knowledge (e.g., common sense knowledge). For example, the trigger may be activated by detecting that one or more possible/expected comments, responses, answers from a discrete set of possible values (e.g., yes/no answers) fails to comply with one or more expected response patterns to one of a plurality of query responses. Said differently, the trigger may be activated upon a dialog system, having the trigger component, expects an answer from a discrete set of possible values (e.g., yes/no answers), but the answers are somewhat more sophisticated, giving an opportunity to learn common sense knowledge such as illustrated in the following dialog conversation between a user and a dialog system (e.g., a dialog agent or “agent”):

### Example 1

Agent: Should I buy this e-book for you, and pay with your credit card?

User: I have a free subscription for the entire year.

### Example 2

Agent: This is a reminder for your soccer game today.

User: I am sick.

### Example 3

Agent: I found a good offer for a holiday in Country A.

User: I am out of vacation days this year.

### Example 4

Agent: How about this steak restaurant?

User: I am a vegetarian.

For each question/comment provided by the dialog system, there are a few discrete expected answers (e.g., yes/no such as, for example, Agent: “How about this steak restaurant?”). When the answer/response provided by the user does not directly match one of the discrete possible values, expected semantic structures, and/or expected types of expected responses, the process of learning judgment reasoning knowledge (e.g., common sense knowledge) may be activated.

In block 520, a lookup operation (e.g., see the response component 412 of FIG. 4) may construct a query with selected keywords and/or concepts from the dialog agent's utterance and the user's utterance such as, for example, “How about this steak restaurant?” and “I am a vegetarian” can lead to a query such as, for example, “steak, restaurant vegan” or “steak vegan.” The lookup component may lookup/search information in a knowledge database (e.g., internet) based on the query (e.g., pose the query to a search engine associated with the internet, knowledge base or ontology database).

In block 530, judgment reasoning knowledge (e.g., common sense knowledge) may be inferred. For example, for inferring the judgment reasoning knowledge, one or more concepts, keywords, or phrases may be provided “input data” such as, for example, two concepts “C1” (e.g., steak restaurant) and concept “C2” (e.g., vegan). The response of the search results may be provided as output data which may be an inferred relationship (“Rel”) between the two concepts such as, for example, Rel(C1, C2) such as, for example, an indication to avoid “steak restaurant” and “vegetarian” or even “vegan.”

In one aspect, the inferring operation may be performed in the following steps. In step 1, let “T1, . . . , Tn” be table representation of a knowledge base where each table Ti is a relation between two or more concepts. The header of table Ti may be the relationship, and each row of table Ti may store specific instances of the respective concepts.

In step 2, a graph “G” may be created where the graph may include nodes corresponding to each of the table cells Eijk (table Ti, row j, col k) and there is a link between table cells Eijk (e.g., an index for a cell at row j, column kin a table Ti and the table cell EijK contains a piece of text) and Ei′j′k′ if there is semantic similarity between the corresponding concept instances. Each edge of the graph “G” may also be assigned a weighted by a value of corresponding semantic similarity measure.

In one aspect, given two cells Eijk and Ei′j′k′, for example, an edge between the two cells can be weighted by the semantic similarity between the corresponding pieces of texts (for determining the weighted value). In the simplest case, for example, the semantic similarity between two works is a real number between 0 and 1, where 1 means that the two words are exactly the same, and 0 means that there's no semantic similarity between the two words (e.g., sim(‘car’, ‘vehicle’)=0.83, sim(‘car’, ‘cat’)=0.)

In step 3, one or more edges may be created between concept C1 and relevant nodes in graph G. One or more edges between concept C2 and relevant nodes in graph G may also be created. In step 4, a maximum weight path “S” may be determined between C1 and C2 that goes through at most one table Tj (e.g., maximum weight path “S” may be determined use a linear programming based approach. In step 5, if the maximum weight path S is not equal to zero (e.g., S!=0) the inferred relation between C1 and C2 may be added to the knowledge base (“KB”) and corresponding table. In step 6, weight path “S” is equal to zero (e.g., S=0), it may be determined/concluded that there is no relation between concepts C1 and concepts C2.

In block 540, the learned judgment reasoning knowledge (e.g., common sense knowledge) may be stored, retained, and/or accessed in a knowledge domain, which may also be used for training a machine learning operation for learning, applying, and/or inferring the judgment reasoning knowledge (e.g., common sense knowledge) for subsequent queries/comments in a dialog.

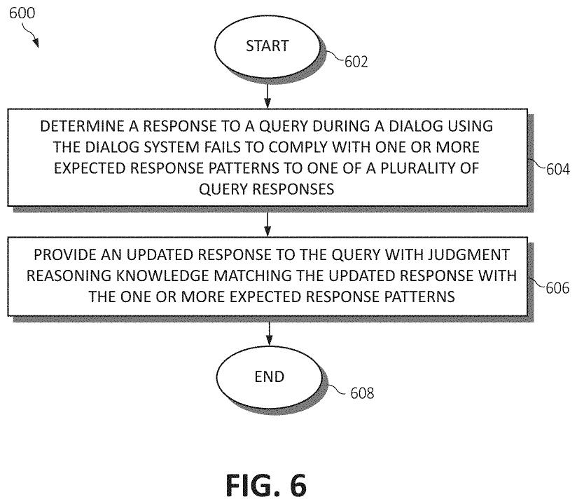

Turning now to FIG. 6, an additional method 700 is illustrated for applying judgment reasoning knowledge in a dialog system in a computing environment, in which various aspects of the illustrated embodiments may be implemented. The functionality 600 may be implemented as a method executed as instructions on a machine, where the instructions are included on at least one computer readable medium or on a non-transitory machine-readable storage medium. The functionality 600 may start in block 602.

A response to a query during a dialog using the dialog system fails to comply with one or more expected response patterns to one of a plurality of query responses, as in block 604. An updated response may be provided to the query using judgment reasoning knowledge for matching the updated response with the one or more expected response patterns, as in block 606. The functionality 600 may end in block 608.

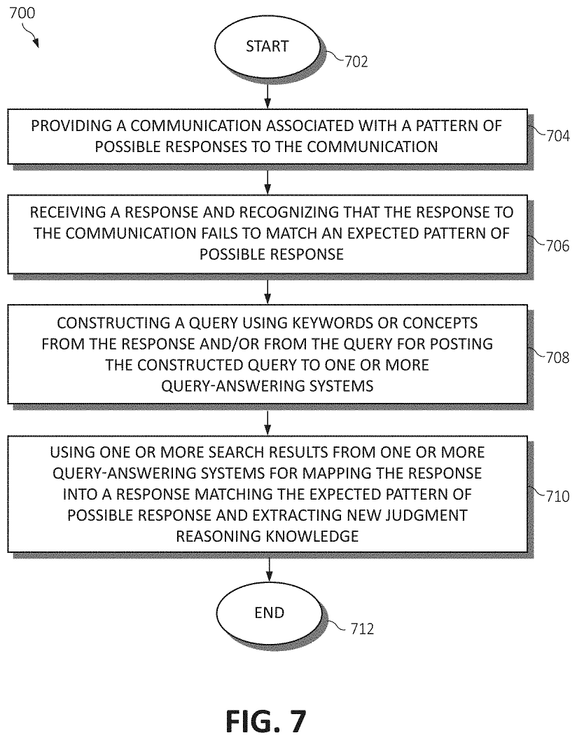

Turning now to FIG. 7, an additional method 700 for applying judgment reasoning knowledge in a dialog system in a computing environment by a processor is depicted, in which various aspects of the illustrated embodiments may be implemented. The functionality 700 may be implemented as a method executed as instructions on a machine, where the instructions are included on at least one computer readable medium or one non-transitory machine-readable storage medium. The functionality 700 may start in block 702.

A communication associated with a pattern of possible responses to the communication may be provided (e.g., posted or communication via a dialog agent/system), as in block 704. A response to the communication may be received (e.g., from a user) and a determination operation may be performed to determine (e.g., identified, determined, recognized, analyzed etc.) that the response fails to match an expected pattern of possible response, as in block 706. A query may be constructed (e.g., created, generated, and/or edited) using one or more keywords and/or concepts from the response and/or from the query for posting the constructed query to one or more query-answering systems, as in block 708. One or more search results may be obtained from one or more query-answering systems for mapping the response into a response matching the expected pattern of possible response and extracting new judgment reasoning knowledge, as in block 710. The functionality 700 may end in block 712.

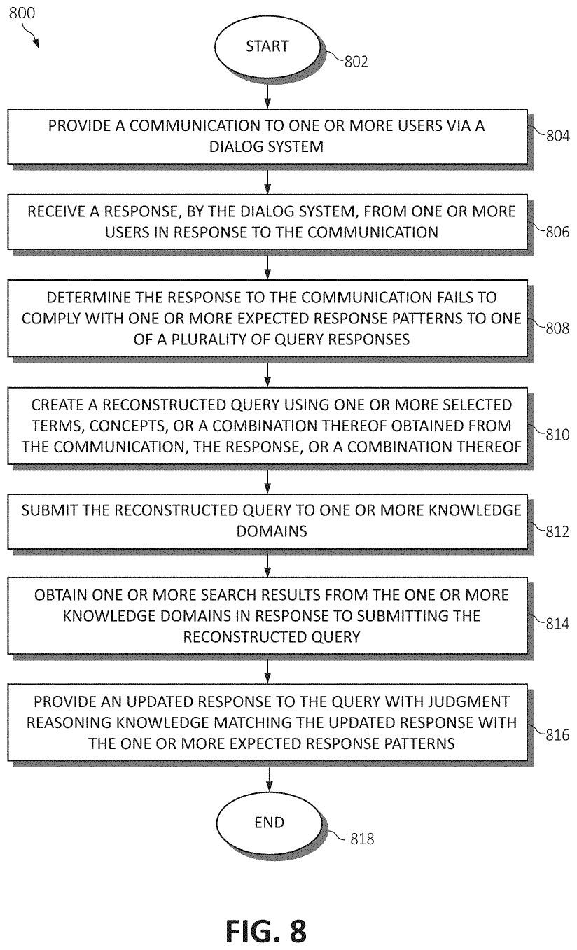

Turning now to FIG. 8, an additional method 800 for applying judgment reasoning knowledge in a dialog system in a computing environment by a processor is depicted, in which various aspects of the illustrated embodiments may be implemented. The functionality 800 may be implemented as a method executed as instructions on a machine, where the instructions are included on at least one computer readable medium or one non-transitory machine-readable storage medium. The functionality 800 may start in block 802.

A communication (e.g., a query, comment, question, etc.) may be provided to one or more users via a dialog system, as in block 804. A response may be received, by the dialog system, from one or more users in response to the communication, as in block 806. The response to the communication may be determined to fail to comply (e.g., the response fails to match an expected pattern for responding to the communication) with one or more expected response patterns to one of a plurality of query responses, as in block 808. A reconstructed query may be created using one or more selected terms, concepts, or a combination thereof obtained from the communication, the response, or a combination thereof, as in block 810. The reconstructed query may be submitted to one or more knowledge domains, as in block 812. One or more search results may be obtained from the one or more knowledge domains in response to submitting the reconstructed query, as in block 814. An updated response to the query may be provided with judgment reasoning knowledge (e.g., inferred and/or applied judgment reasoning knowledge) matching the updated response with the one or more expected response patterns, as in block 816. The functionality 800 may end in block 818.

In one aspect, in conjunction with and/or as part of at least one block of FIGS. 6-8 the operations of 600, 700, and/or 800 may include each of the following. The operations of 600, 700, and/or 800 may map the one or more search results into the updated response, and/or learn and extract the judgment reasoning knowledge from the one or more search results. The operations of 600, 700, and/or 800 may map the response relating to one or more concepts with one or more search results provided in a plurality of tables representing each knowledge domain, create a graph with a plurality of nodes representing a plurality of cells of in each table corresponding to each knowledge domain, wherein each of the plurality of cells represent a one or more concepts, identify a link between one or more of the plurality of nodes having a semantic similarity, and/or assign a weighted value between each path of each link between the one or more of the plurality of nodes.

The operations of 600, 700, and/or 800 may initialize a machine learning mechanism to learn, extract, and infer the judgment reasoning knowledge. An interface of the dialog system (e.g., a graphical user interface ‘GUI’) may be personalized, customized, and/or adjusted according to the dialog.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

What is claimed is:

1. A method, by a processor, for applying judgment reasoning knowledge in a dialog system, comprising:
determining a response to a query, during a dialog using the dialog system, fails to comply with one or more expected response patterns to one of a plurality of query responses; and
providing an updated response to the query with judgment reasoning knowledge matching the updated response with the one or more expected response patterns.

2. The method of claim 1, further including:
providing a reconstructed query using one or more selected terms, concepts, or a combination thereof obtained from the query, the response, or a combination thereof;
submitting the reconstructed query to a knowledge domain; and
obtaining one or more search results from the knowledge domain in response to submitting the reconstructed query.

3. The method of claim 2, further including mapping the one or more search results into the updated response.

4. The method of claim 2, further including learning and extracting the judgment reasoning knowledge from the one or more search results.

5. The method of claim 1, further including further mapping the response relating to one or more concepts with one or more search results provided in a plurality of tables representing each knowledge domain.

6. The method of claim 1, further including:
creating a graph with a plurality of nodes representing a plurality of cells of in each table corresponding to each knowledge domain, wherein each of the plurality of cells represent a one or more concepts;
identifying a link between one or more of the plurality of nodes having a semantic similarity; and
assigning a weighted value between each path of each link between the one or more of the plurality of nodes.

7. The method of claim 1, further including initializing a machine learning mechanism to learn, extract, and infer the judgment reasoning knowledge.

8. A system, for applying judgment reasoning knowledge in a dialog system in a computing environment, comprising:
one or more processors with executable instructions that when executed cause the system to:
determine a response to a query, during a dialog using the dialog system, fails to comply with one or more expected response patterns to one of a plurality of query responses; and
provide an updated response to the query using judgment reasoning knowledge for matching the updated response with the one or more expected response patterns.

9. The system of claim 8, wherein the executable instructions further:
provide a reconstructed query using one or more selected terms, concepts, or a combination thereof obtained from the query, the response, or a combination thereof;
submit the reconstructed query to a knowledge domain; and
obtain one or more search results from the knowledge domain in response to submitting the reconstructed query.

10. The system of claim 9, wherein the executable instructions further map the one or more search results into the updated response.

11. The system of claim 9, wherein the executable instructions further learn and extract the judgment reasoning knowledge from the one or more search results.

12. The system of claim 8, wherein the executable instructions further map the response relating to one or more concepts with one or more search results provided in a plurality of tables representing each knowledge domain.

13. The system of claim 8, wherein the executable instructions further:
create a graph with a plurality of nodes representing a plurality of cells of in each table corresponding to each knowledge domain, wherein each of the plurality of cells represent a one or more concepts; and
identify a link between one or more of the plurality of nodes having a semantic similarity; and
assign a weighted value between each path of each link between the one or more of the plurality of nodes.

14. The system of claim 8, wherein the executable instructions further initialize a machine learning mechanism to learn, extract, and infer the judgment reasoning knowledge.

15. A computer program product for, by one or more processors, applying judgment reasoning knowledge in a dialog system in a computing environment, the computer program product comprising a non-transitory computer-readable storage medium having computer-readable program code portions stored therein, the computer-readable program code portions comprising:
an executable portion that determines a response to a query, during a dialog using the dialog system, fails to comply with one or more expected response patterns to one of a plurality of query responses; and
an executable portion that provides an updated response to the query using judgment reasoning knowledge for matching the updated response with the one or more expected response patterns.

16. The computer program product of claim 15, further including an executable that:
provides a reconstructed query using one or more selected terms, concepts, or a combination thereof obtained from the query, the response, or a combination thereof;
submits the reconstructed query to a knowledge domain; and
obtains one or more search results from the knowledge domain in response to submitting the reconstructed query.

17. The computer program product of claim 16, further including an executable that:
maps the one or more search results into the updated response; or
learns and extracts the judgment reasoning knowledge from the one or more search results.

18. The computer program product of claim 15, further including an executable that maps the response relating to one or more concepts with one or more search results provided in a plurality of tables representing each knowledge domain.

19. The computer program product of claim 15, further including an executable that:
creates a graph with a plurality of nodes representing a plurality of cells of in each table corresponding to each knowledge domain, wherein each of the plurality of cells represent a one or more concepts; and
identifies a link between one or more of the plurality of nodes having a semantic similarity; and
assigns a weighted value between each path of each link between the one or more of the plurality of nodes.

20. The computer program product of claim 15, further including an executable that initializes a machine learning mechanism to learn, extract, and infer the judgment reasoning knowledge.
